(19) United States
(12) Patent Application Publication
(10) Pub. No.: US 2018/0157381 A1
(43) Pub. Date: Jun. 7, 2018

(54) SYSTEMS AND METHODS FOR MEDIA ITEM SELECTION WITHIN A GRID-BASED CONTENT FEED

(71) Applicant: Facebook, Inc., Menlo Park, CA (US)

(72) Inventors: Hyun Woo Jung, Redwood City, CA (US); Ryan Michael O'Rourke, San Francisco, CA (US); John Raymond Edstrom, San Francisco, CA (US); Shiyi Zhao, San Mateo, CA (US)

(21) Appl. No.: 15/368,389

(22) Filed: Dec. 2, 2016

(51) Int. Cl. G06F 3/0482; H04L 12/58

(52) U.S. Cl. CPC G06F 3/0482; G06T 3/20; G06F 2203/04803; H04L 51/32

(57) ABSTRACT

Systems, methods, and non-transitory computer-readable media can present a grid-based content feed comprising a plurality of media content items, the plurality of media content items comprising a first video channel, and the first video channel comprising a plurality of videos. An indication is received that a user has selected the first video channel. The grid-based content feed is transitioned into an immersive viewer in which the first video channel is presented. The first video channel is presented within the immersive viewer.

### FIELD OF THE INVENTION

The present technology relates to the field of social networking systems. More particularly, the present technology relates to systems and methods for media item selection within a grid-based content feed.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be provided with a graphical user interface to view and interact with the social networking system. For example, the graphical user interface can be presented via a mobile application on a user's mobile device. The graphical user interface can provide users with the ability to view and otherwise interact with content on the social networking system, such as content items posted to the social networking system by other users. For example, a user can view photos and videos or listen to audio files posted by other users.

### SUMMARY

Various embodiments of the present disclosure can include systems, methods, and non-transitory computer readable media configured to present a grid-based content feed comprising a plurality of media content items, the plurality of media content items comprising a first video channel, and the first video channel comprising a plurality of videos. An indication is received that a user has selected the first video channel. The grid-based content feed is transitioned into an immersive viewer in which the first video channel is presented. The first video channel is presented within the immersive viewer.

In an embodiment, the presenting the grid-based content feed comprises automatically initiating playback of the video channel within the grid-based content feed.

In an embodiment, the playback of the video channel continues through the transitioning from the grid-based content feed to the immersive viewer and the presenting the first video channel within the immersive viewer.

In an embodiment, the immersive viewer is transitioned back to the grid-based content feed and the grid-based content feed is presented. The playback of the video channel continues through the transitioning from the immersive viewer to the grid-based content feed and through the presenting the grid-based content feed.

In an embodiment, the transitioning from the grid-based content feed to the immersive viewer comprises translating the remaining plurality of media content items other than the first video channel off screen.

In an embodiment, the transitioning from the grid-based content feed to the immersive viewer further comprises translating the video channel to a center portion of a display.

In an embodiment, the transitioning from the grid-based content feed to the immersive viewer further comprises expanding the first video channel from a cropped view to an uncropped view of the first video channel.

In an embodiment, the video channel comprises a plurality of videos that are added to the video channel based on a shared characteristic.

In an embodiment, the video channel comprises a plurality of videos that are associated with a particular topic.

In an embodiment, the video channel comprises a plurality of videos that are associated with a particular event.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a content interaction interface module, according to an embodiment of the present disclosure.

FIG. 2A illustrates an example scenario associated with presenting a grid-based content feed, according to an embodiment of the present disclosure.

FIG. 2B illustrates an example scenario associated with transitioning from a grid-based content feed to an immersive viewer, according to an embodiment of the present disclosure.

FIG. 3A illustrates an example scenario associated with presenting a video channel in an immersive viewer, according to an embodiment of the present disclosure.

FIG. 3B illustrates an example scenario associated with interacting with an immersive viewer, according to an embodiment of the present disclosure.

FIG. 4A illustrates an example scenario associated with transitioning from an immersive viewer to a grid-based content feed, according to an embodiment of the present disclosure.

FIG. 4B illustrates an example scenario associated with presenting a grid-based content feed, according to an embodiment of the present disclosure.

FIG. 5 illustrates an example method associated with transitioning between a grid-based content feed and an immersive viewer, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Media Item Selection within a Grid-Based Content Feed

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be provided with a graphical user interface to view and interact with the social networking system. For example, the graphical user interface can be presented via a mobile application on a user's mobile device. The graphical user interface can provide users with the ability to view and otherwise interact with content on the social networking system, such as content items posted to the social networking system by other users. For example, a user can view photos and videos or listen to audio files posted by other users.

It continues to be an important interest for a social networking system to encourage users to interact with content on the social networking system. Continued user interaction with content posted to the social networking is an important aspect of maintaining continued interest in and participation on the social networking system. A related issue is the issue of providing users with graphical user interfaces that allow users to view and interact with content on the social networking in an easy and intuitive manner that will encourage further interaction by users. Conventional graphical user interfaces and their functionality can be unintuitive, cumbersome to navigate, visually unattractive, or otherwise functionally suboptimal, leading to frustration and loss of interest by users.

An improved approach rooted in computer technology overcomes the foregoing and other disadvantages associated with conventional approaches specifically arising in the realm of computer technology. In general, a graphical user interface can be presented to a user in which the user can transition between a grid-based content feed and an immersive viewer. In various embodiments, a user can be presented with a grid-based content feed in which a plurality of media content items are presented. The grid-based content feed can include various display elements, such as a search bar, an action bar, and the plurality of media content items. The user can navigate the grid-based content feed to view and interact with the plurality of media content items. By selecting a particular media content item, the user can cause the graphical user interface to transition from the grid-based content feed to an immersive viewer in which the selected media content item is highlighted or featured.

In various embodiments, the plurality of media content items can include one or more video channels comprising a plurality of videos. The plurality of videos in a video channel may be grouped together based on a shared characteristic. For example, a video channel may be associated with a particular topic, and contain videos relating to that topic, or associated with a particular event, and contain videos relating to that event. When a video channel is presented in the grid-based content feed, the video channel can automatically begin playing videos from the video channel. In this way, the user is provided with a preview of the video channel as the user scrolls through the grid-based content feed. If the user wishes to view the video channel, the user can continue watching the preview, or the user can select the video channel to open an immersive viewer. If the user selects the video channel to open the immersive viewer, the graphical user interface can transition from the grid-based content feed to the immersive viewer by pushing all display elements other than the video channel off the display. As the other display elements are being pushed off screen, the video channel can be centered on the screen. Within the immersive viewer, the user can interact with the video channel to, for example, move between videos in the video channel (e.g., move to a next video or a previous video in the video channel). The user can close the immersive viewer to transition back to the grid-based content feed. The transition from the immersive viewer to the grid-based content feed can include moving display elements for the grid-based content feed back into the graphical user interface. During the transition from grid-based content feed, to immersive viewer, and back to the grid-based content feed, playback of the video channel can resume through each transition in a substantially uninterrupted manner.

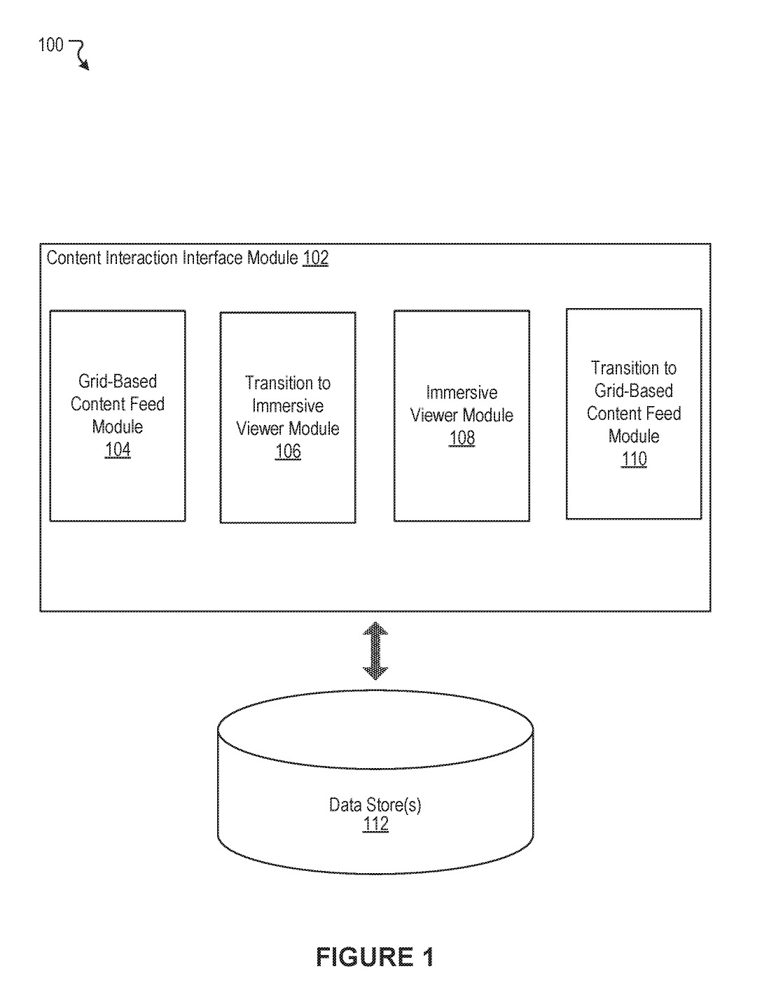

FIG. 1 illustrates an example system 100 including a content interaction interface module 102, according to an embodiment of the present disclosure. The content interaction interface module 102 can be configured to provide a graphical user interface via which a user can interact with various content items. For example, the graphical user interface can present a plurality of media content items in a grid-based content feed. At any given time, the graphical user interface may present only a portion of the plurality of media content items in the grid-based content feed, and a user can navigate through the grid-based content feed to reveal additional media content items by, for example, swiping or scrolling through the grid-based content feed. The user can cause the graphical user interface to transition from the grid-based content feed to an immersive viewer by selecting a particular media content item. The immersive viewer can present the particular media content item in a view that highlights or features the particular media content item.

In certain embodiments, the plurality of media content items presented in the grid-based content feed can include one or more video channels. When a user selects a video channel, the graphical user interface can transition from the grid-based content feed to an immersive viewer in which the video channel is highlighted. The video channel may be highlighted by removing some or all other display elements in the graphical user interface other than the video channel. For example, any media content items aside from the video channel can be pushed off screen. The graphical user interface may also include additional display elements, such as a search bar and/or an action bar. These display elements can also be pushed off screen so that the user is presented with only the video channel, and possibly additional information pertaining to the video channel. When the user closes the immersive viewer, the graphical user interface can transition back into the grid-based content feed by translating display elements from off screen back into the display.

In certain embodiments, when a video channel is presented in a grid-based content feed, the video channel can begin playing automatically within the grid-based content feed to provide a “preview” of the video channel. When the immersive viewer is opened for the video channel, the video channel can continue playing during the transition from the grid-based content feed to the immersive viewer such that video playback is uninterrupted or substantially uninterrupted during the transition. Similarly, when the immersive viewer is closed, and the immersive viewer transitions into the grid-based content feed, the video channel can continue to play throughout the transition and within the grid-based content feed, such that, once again, video playback is uninterrupted or substantially uninterrupted during the transition from the immersive viewer back into the grid-based content feed. Further features of the graphical user interface and the content interaction interface module 102 will be described in greater detail herein.

As shown in the example of FIG. 1, the content interaction interface module 102 can include a grid-based content feed module 104, a transition to immersive viewer module 106, an immersive viewer module 108, and a transition to grid-based content feed module 110. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the content interaction interface module 102 can be implemented in any suitable combinations.

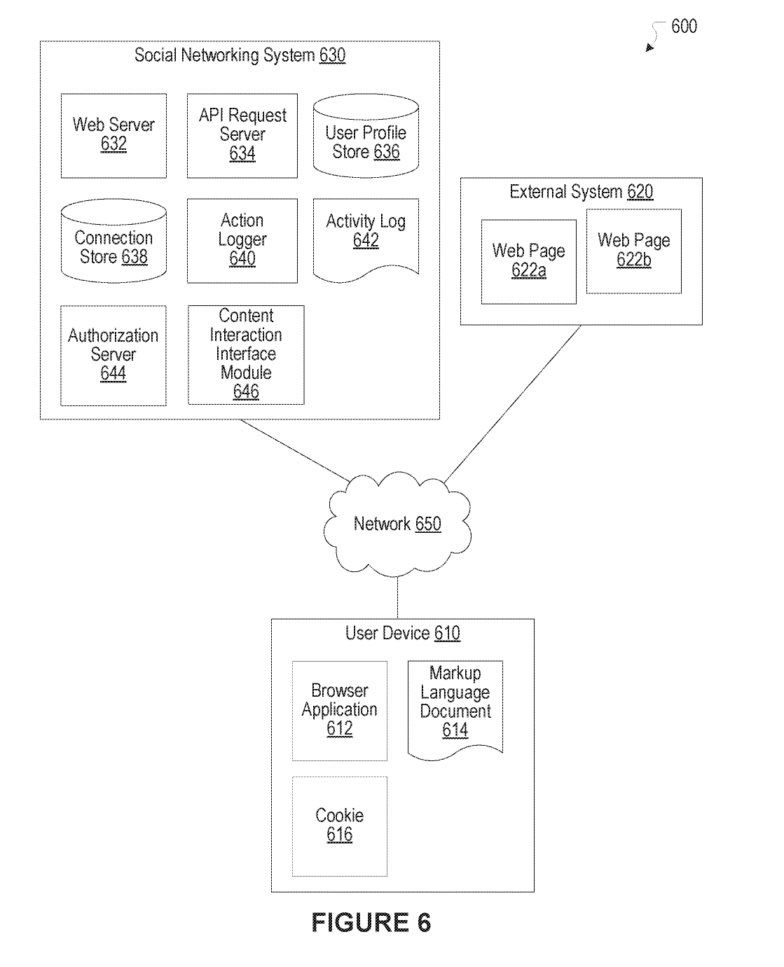

In some embodiments, the content interaction interface module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the content interaction interface module 102 can be implemented, in part or in whole, as software running on one or more computing devices or systems, such as on a user or client computing device. For example, the content interaction interface module 102, or at least a portion thereof, can be implemented as or within an application (e.g., app), a program, or an applet, etc., running on a user computing device or a client computing system, such as the user device 610 of FIG. 6. In another example, the content interaction interface module 102, or at least a portion thereof, can be implemented using one or more computing devices or systems that include one or more servers, such as network servers or cloud servers. In some instances, the content interaction interface module 102 can, in part or in whole, be implemented within or configured to operate in conjunction with a social networking system (or service), such as the social networking system 630 of FIG. 6. It should be understood that there can be many variations or other possibilities.

The content interaction interface module 102 can be configured to communicate and/or operate with the at least one data store 112, as shown in the example system 100. The data store 112 can be configured to store and maintain various types of data. In some implementations, the data store 112 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 112 can store information that is utilized by the content interaction interface module 102. For example, the data store 112 can store one or more graphical user interfaces, media content items, video channel information, and the like. It is contemplated that there can be many variations or other possibilities.

The grid-based content feed module 104 can be configured to present a grid-based content feed in a graphical user interface. The grid-based content feed can include a plurality of media content items for a user to view and interact with. In certain embodiments, the plurality of media content items presented in a user's grid-based content feed may be selected and presented based on a ranking of media content items. Media content items may be ranked based on various ranking criteria. For example, media content items may be ranked based on likelihood of interest to the user, or based on the probability the user will interact with a particular media content item, and the like.

In various embodiments, the grid-based content feed can include various display elements that are displayed in the graphical user interface. Display elements can include the plurality of media content items that are presented in the grid-based content feed, as well as additional display elements, such as a search bar that allows a user to perform various searching functions. The grid-based content feed can also include an action bar that allows the user to take various actions within the graphical user interface. For example, the action bar can include a “home” icon that takes a user back to a home screen, or a camera icon that opens up a camera application on the user's computing device, or a “like” icon to react to a particular media content item, and the like.

The plurality of media content items presented in the grid-based content feed can include various types of media content items, such as images and videos. The plurality of media content items can also include video channels. Video channels can be collections of multiple videos. Video channels can collect and group videos together based on a shared characteristic. For example, a video channel can be associated with a particular topic or theme, and the video channel can include videos relating to that topic or theme (e.g., a video channel for dog videos, or a video channel for baby videos). In another example, a video channel can be associated with a particular event, such that the video channel includes videos relating to that event (e.g., a video channel comprising multiple videos taken at a particular concert or music festival).

Videos for video channels can be collected in various ways. For example, videos for a topic-based video channel associated with a particular topic can be sourced from one or more accounts on a social networking system associated with the particular topic. For example, if a video channel is associated with knitting, the top 100 accounts associated with knitting can be identified, and the video channel can include videos posted to the social networking system by these accounts. In another example, videos for an event-based video channel associated with a particular event can be sourced based on users tagging their videos with the particular event. In certain embodiments, if users are posting videos to a social networking system, they may be given the ability to “tag” the video with an event tag indicating that the video was taken at a particular event. Videos for a video channel may be sourced manually, algorithmically, or a combination of the two. For example, in the example scenario of sourcing videos from a plurality of user accounts associated with a particular topic, the set of accounts and the videos from those accounts may be determined automatically and algorithmically. In an alternative embodiment, the plurality of user accounts may be selected by a curator, and videos can be automatically pulled from those accounts. Videos may be ranked based on video ranking criteria, and videos may be selected for a video channel and/or presented in a video channel based on the ranking. For example, the top n videos based on the ranking may be selected for a video channel, and may be presented in the video channel based on the order of the ranking.

As a user navigates through a grid-based content feed, various media content items may be moved into and out of view on a display screen on the user's computing device. For example, if a user scrolls up through a grid-based content feed, media content items may move off the display screen at the top of the display, and new media content items may move into the display screen from the bottom of the display. When a video channel moves into the display screen, the video channel may begin automatically playing within the grid-based content feed. In this way, the user is presented with a preview of the video channel. Presentation of the video channel in the grid-based content feed may also include an indication of the video channel's content. For example, if the video channel is a collection of videos from a particular event, the video channel may have a textual overlay stating the name of the particular event. Or if the video channel is a collection of videos about basketball, the video channel may have a textual overlay that reads “Basketball Videos.”

The transition to immersive viewer module 106 can be configured to transition a graphical user interface from a grid-based content feed to an immersive viewer. When a user selects a particular media content item from the grid-based content feed, the graphical user interface can transition from the grid-based content feed to an immersive viewer which highlights or features the particular media content item. For example, if a user selects a video channel within the grid-based content feed, the graphical user interface may transition from the grid-based content feed to an immersive viewer that presents the selected video channel. In various embodiments, the transition from the grid-based content feed to the immersive viewer can comprise moving one or more display elements off the graphical user interface so as to highlight the selected media content item (e.g., a video channel). For example, all media content items aside from the selected media content item may be moved off screen. In certain embodiments, all display elements that do not pertain to the selected media content item may be moved off screen, including, for example, a search bar, an action bar, other media content items, and/or other display elements in the grid-based content feed.

The transition from the grid-based content feed to the immersive viewer may also include modifying the display of the selected media content item. For example, if the selected media content item is a video channel, the video channel can be moved from its location within the grid-based content feed to the center of the display. In certain embodiments, the presentation of the video channel within the grid-based content feed may be a cropped view of the video channel. In other words, certain portions of the video channel may not be visible in the grid-based content feed. For example, a top portion, a bottom portion, a left portion, and/or a right portion of the video may be cropped and non-visible in the grid-based content feed. The transition from the grid-based content feed to the immersive viewer can include expanding the cropped view of the video channel into an uncropped, full view of the video channel.

The various visual effects of transitioning from the grid-based content feed to the immersive viewer may be carried out in various ways. In one embodiment, the visual effects may be carried out by taking screenshots or images of the display elements in the grid-based content feed, and modifying them appropriately. For example, screenshots of display elements aside from the selected media content item can be taken and translated (i.e., moved) so as to give the visual effect that these display elements are moving off screen. Similarly, any movement or translation of the selected media content item, e.g., a video channel, can be effected by moving or translating an image screenshot of the selected media content item. The visual effect of expanding a media content item from a cropped view to an uncropped view can also be carried out by taking a screenshot of the uncropped view, and gradually unveiling the cropped portion of the media content item to achieve the desired visual effect of transitioning from the cropped view to the uncropped view. Once the transition is completed (e.g., all display elements that are to be moved off screen have been moved off screen, and the video channel has been centered and expanded into the uncropped view), the screenshot images that were used to carry out the visual effect can be removed to reveal the immersive viewer in such a manner that the user's visual experience is substantially seamless. For example, a video channel may be playing within a grid-based content feed. If the user selects the video channel, the graphical user interface can transition into an immersive viewer for the video channel. Screenshots can be taken of all data elements other than the video channel and those screenshots can be translated off screen to make it appear that the data elements are moving off screen. A screenshot of the video channel can be taken at the moment the user selects the video channel, and the screenshot can be translated to the center of the display. If the video channel was cropped in the grid-based content feed, the screenshot of the video channel can gradually expand from the cropped view to the uncropped view. The graphical user interface can then remove the screenshot(s) to reveal the immersive viewer. Since the screenshots were used to emulate the appearance of the immersive viewer, removal of the screenshots to present the immersive viewer should be substantially seamless and unnoticeable to the user. In the case of a video channel that is playing throughout the transition, the screenshot would be a still image, and would, therefore, result in a slight disturbance in the video playback since the user would see a still image rather than a moving video. However, the transition can take place fairly quickly, such that once the screenshots are removed and the immersive viewer is presented, the immersive viewer is already playing the video channel and the user only sees a quick pause in the video playback. As such, the user is given the effect of substantially uninterrupted video playback during the transition from the grid-based content feed to the immersive viewer.

In another embodiment, rather than taking screenshots and moving the screenshots, the visual effects may be carried out by actually moving display elements themselves. This may be a more desirable, in certain embodiments, as taking and translating screenshots can result in consumption of memory and related processing delays. Furthermore, in the case of a video channel, even the quick disturbance in video playback can potentially be avoided, as it is the actual video channel display element that is being moved and/or expanded as it is playing, rather than a screenshot of the video channel.

An example procedure for translating display elements will now be described with various example implementations in an Android graphical user interface. In an initial stage of the transition, preparatory action can be taken to prepare the graphical user interface and the display elements contained therein for the transition from the grid-based content feed to the immersive viewer. For example, in an Android graphical user interface, all ViewGroups can be unclipped starting from the ListView's children and traversing up the View hierarchy to the topmost DecorView to prevent Views from being clipped by their parents' bounds as they are translated. In an Android graphical user interface, preparatory steps can also include showing an empty, no style dialog with setCancelable(false) to ensure that the user cannot press the back button during the transition animation so as to avoid unexpected results.

One or more display elements can be added to the grid-based content feed to mimic the appearance of the immersive viewer while transitioning into the immersive viewer. For example, in an Android graphical user interface, a FrameLayout (which will be referred to as View X) can be added to the topmost DecorView. The display element that is playing the video channel within the grid-based content feed can be tied to a topmost view to keep the video channel playing through the transition. For example, in an Android graphical user interface, the TextureView that is playing the video channel video can be re-bound to a MediaFrameLayout instance inside View X. All data elements (e.g., Views in the Android context) in the grid-based content feed can be translated off screen except for the video channel data element (e.g., the View X). The video channel data element can then be translated to its final position, e.g., the center of the display.

Once all translation is complete, the immersive viewer can be launched. As the viewer is being presented with the immersive viewer, various cleanup tasks can be undertaken in the background with respect the grid-based content feed. For example, for an Android graphical user interface, once the new fragment (the immersive viewer) is being displayed, and the original video View from the old fragment (the grid-based content feed) is detached from the window, the translation of all Views that were moved out of screen can be reset. This ensures that these Views will be present when the immersive viewer is transitioned back into the grid-based content feed at a later time. Finally, the View X that was added to the topmost DecorView can be removed from the topmost DecorView so that it can be garbage collected and in order to prevent leaking memory allocated to it.

The immersive viewer module 108 can be configured to present an immersive viewer in a graphical user interface. As discussed above, an immersive viewer may be a view in which a particular media content item is highlighted or featured. In certain embodiments, a particular media content item is featured by being the only media content item presented within the immersive viewer. The immersive viewer may include additional information associated with the particular media content item, such as a user ID of the user that posted the media content item to a social networking system, or a caption associated with the media content item.

In the case of an immersive viewer presenting a video channel, the video channel can include a plurality of videos in a particular order, such that videos are positioned before or after one another in the video channel. The immersive viewer can include a center, featured portion that plays a current, featured video. The immersive viewer can also include “previous” and “next” positions that allow a user to see videos that are positioned immediately before and immediately after the current video. For example, if a current video is playing in the center of the immersive viewer, a space above the current video can represent a “previous” position and can include a still image for another video positioned immediately before the current video within the video channel. Similarly, a space below the currently playing video can represent a “next” position and can present a still image for another video that is positioned immediately after the current video within the video channel. In this embodiment, when the current video finishes playing, it can move upward into the “previous” position, the video that was previously in the “previous” position moves off screen, the video that was in the “next” position moves into the center, featured position, and a video positioned immediately after the video that was in the “next” position moves from off screen into the “next” position. The user can navigate between videos in the video channel by, for example, swiping up or down.

In certain embodiments, the center, featured position can be visually emphasized and the “previous” and “next” positions can be visually deemphasized or obscured. For example, the “previous” and “next” positions may be darker than the center, featured position. The visual effect of emphasizing the center, featured video and deemphasizing the videos in the “previous” and “next” positions can be carried out in any appropriate manner, including, for example, making the “previous” and “next” positions more opaque, more transparent, less saturated, and/or more blurry than the center, featured position. When a user causes videos to move from either the “previous” or “next” positions into the featured position, e.g., by swiping up or down, the user's action may cause the video moving into the featured position to gradually acquire the visual characteristics of the feature position (e.g., becoming brighter, more opaque, more saturated, less blurry, etc.). Similarly, the video being moved from the featured position into either the “previous” or “next” position may gradually acquire the visual characteristics of the “previous” or “next” position (e.g., becoming darker, more transparent, less saturated, more blurry, etc.).

When a user wishes to exit out of the immersive viewer and return to the grid-based content feed, the user can take a particular action within the immersive viewer to do so. For example, an icon can be provided for the user to exit out of the immersive viewer when the icon is selected.

The transition to grid-based content feed module 110 can be configured to transition a graphical user interface from an immersive viewer to a grid-based content feed. The transition from the immersive viewer to the grid-based content feed can be substantially similar to the transition from the grid-based content feed to the immersive viewer, but in reverse. As was the case with the previously discussed transition, the visual effect of the transition can be performed in a number of ways. For example, screenshots can be used to move data elements back into the screen to create the visual effect of transitioning from the immersive viewer to the grid-based content feed.

In another embodiment, display elements themselves can be moved back into view to display the grid-based content feed. Once again, an example procedure will be discussed with example implementations for an Android graphical user interface. Various preparatory measures can be taken to prepare for the transition from the immersive viewer to the grid-based content feed. For example, in an Android graphical user interface, an empty, no style dialog with setCancelable(false) can be shown to ensure that the user cannot press the back button during the transition animation so as to avoid unexpected results.

One or more display elements can be added to the display to mimic the appearance of the immersive viewer while transitioning into the grid-based content feed. For example, in an Android graphical user interface, a FrameLayout (which will be referred to as View X) can be added to the topmost DecorView. A display element that is playing the video channel can be tied to a topmost view to keep the video channel playing through the transition. For example, in an Android graphical user interface, the TextureView that is playing the video channel video can be re-bound to a MediaFrameLayout instance inside View X. The immersive viewer can then be replaced with the grid-based content feed. For example, in an Android graphical user interface, the graphical user interface can pop the back stack so that the grid-based content feed will be rendered. However, just before the grid-based content feed is drawn on screen (e.g., in onPreDraw), the TextureView that is playing the video channel video can be rebound to View X, as popping the back stack may cause the TextureView to automatically get rebound to a new video view in the grid-based content feed.

Various data elements that will be moved into the grid-based content feed can be prepared for translation into the display. For example, in an Android graphical user interface, in the onPreDraw( ) callback, ViewGroups can be unclipped (e.g., by setting setClipChildren and setClipToPadding to false) so that translating Views will not be clipped outside their parents' bounds. The initial translation of the translating Views can be set to start outside of the screen, so that they are not visible at the start of the translation, and then the data elements (Views) can be translated into the screen. The video channel data element (e.g., the MediaFrameLayout instance in View X) can be translated to its final position in the grid-based content feed. The target video View in the grid-based content feed can be faded in so that the text overlay on the video channel (which is shown in the grid-based content feed but not in the immersive view) fades in smoothly rather than popping in at the end of the transition.

Once all translation is completed, various cleanup tasks may be performed. For example, for an Android graphical user interface, this can include resetting the clipping on all ViewGroups that were previously unclipped, rebinding the TextureView back to the video View in the grid-based content feed, and removing the View X from the topmost DecorView so that it can be garbage collected and so as to prevent leaking memory allocated to it.

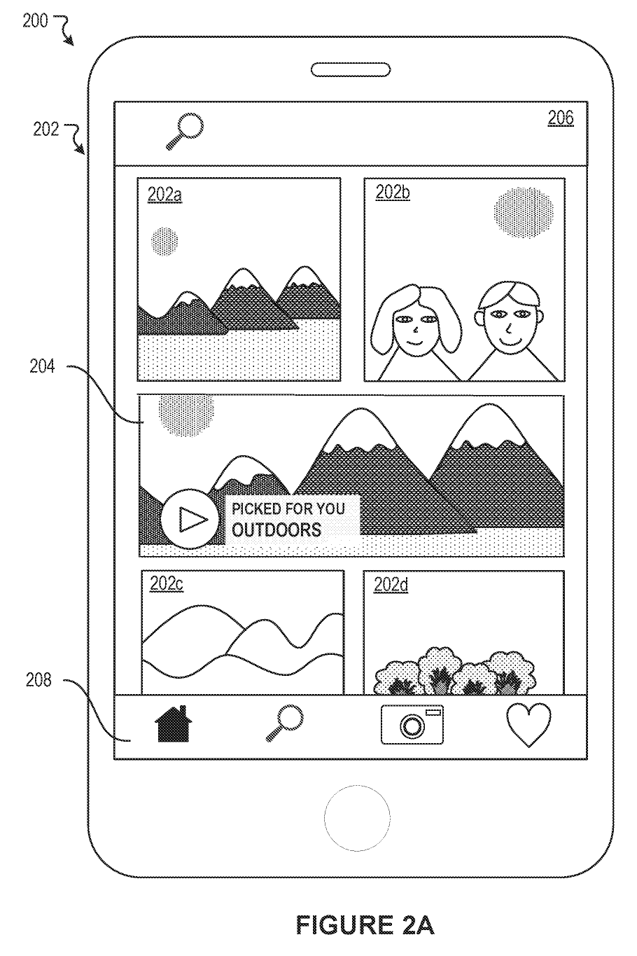

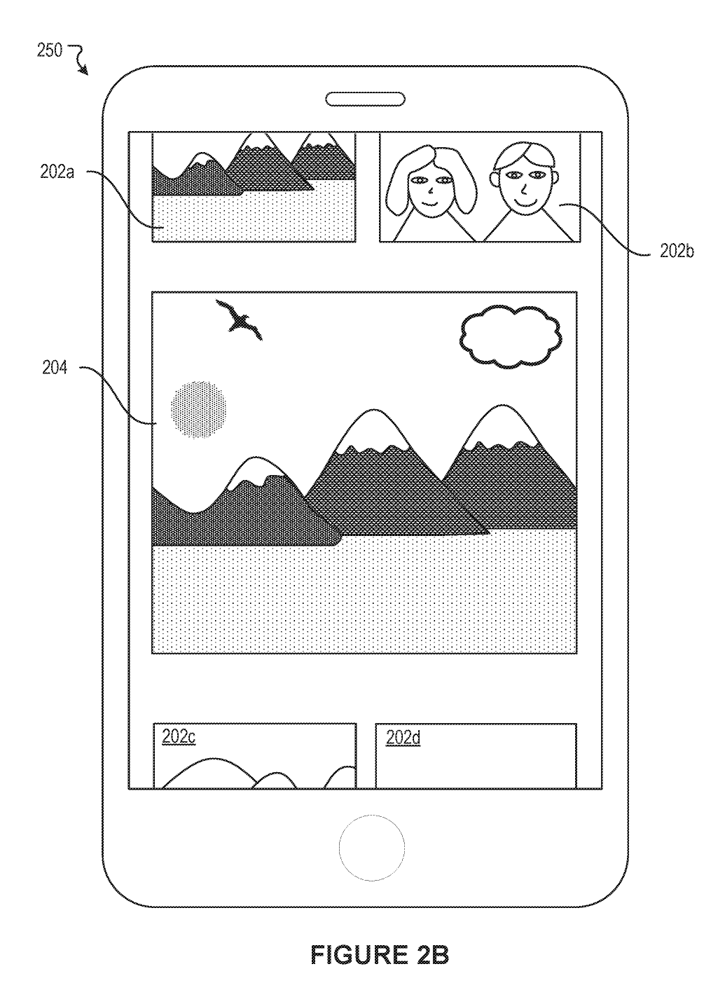

FIG. 2A illustrates an example scenario associated with presenting a grid-based content feed. The example scenario 200 includes a graphical user interface presenting a grid-based content feed 202 in which a plurality of media content items 202a-d and 204 are presented. The plurality of media content items include a video channel 204. When the graphical user interface presents the video channel 204 within the grid-based content feed 202, the video channel 204 may automatically begin playing. The graphical user interface also includes additional display elements, such as a search bar 206 and an action bar 208.

FIG. 2B illustrates an example scenario 250 associated with transitioning from a grid-based content feed to an immersive viewer. In the example scenario 250, a user has selected the video channel 204 to open an immersive viewer. In the example scenario 250, the graphical user interface is in the middle of transitioning from the grid-based content feed 202 of FIG. 2A to an immersive viewer. The display elements 206 and 208 have translated off screen, and media content items 202a-d are in the process of being translated off screen. The video channel 204 has been repositioned to the center of the screen, and has been expanded from a cropped view in the grid-based content feed 202 of FIG. 2A to an expanded, uncropped view. As the transition is taking place, playback of the video channel can continue through the transition. In other words, the user can continue watching the video channel as the graphical user interface is being transitioned from the grid-based content feed to the immersive viewer.

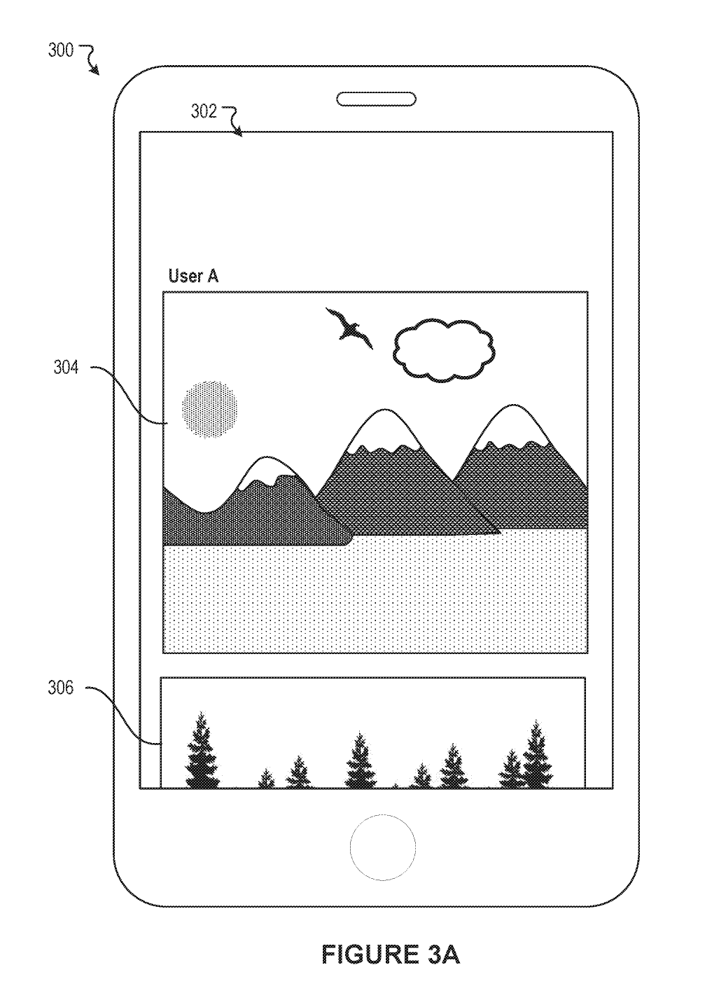

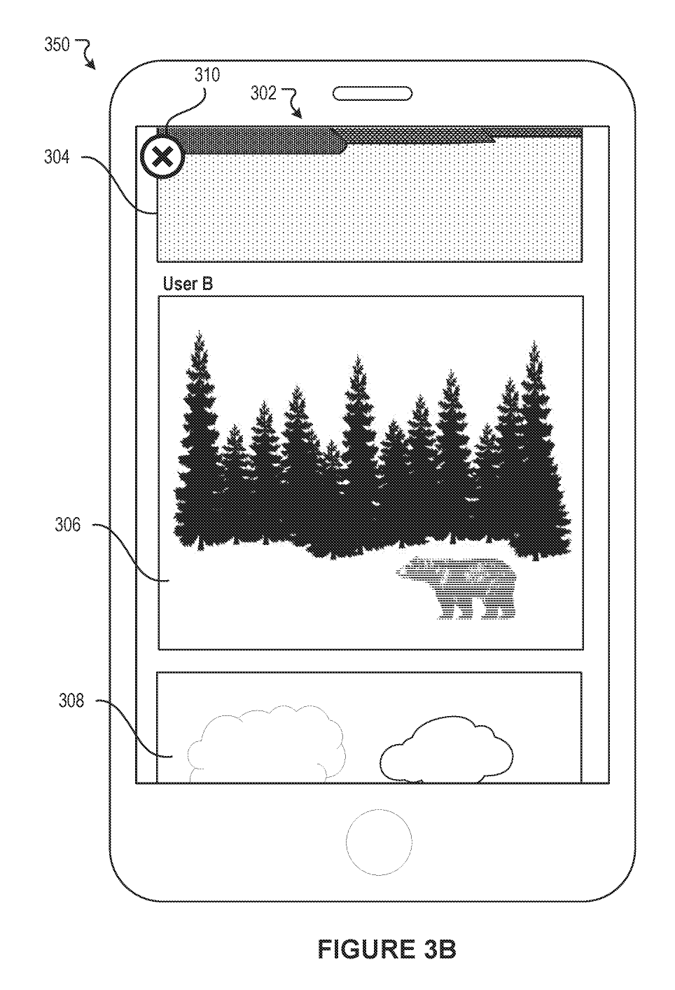

FIG. 3A illustrates an example scenario 300 associated with presenting an immersive viewer. The transition to an immersive viewer 302 has been completed. Playback of a first video 304 of the video channel began within the grid-based content feed, and continued through the transition from the grid-based content feed into the immersive viewer. Now, within the immersive viewer, playback of the first video 304 continues (e.g., uninterrupted or substantially uninterrupted). The first video 304 of the video channel is presented in a center portion of the display. Below the first video 304 is a second video 306 of the video channel.

FIG. 3B illustrates an example scenario 350 associated with interacting with an immersive viewer. In the example scenario 350, the first video 304 has been moved to an upper portion of the display, the second video 306 has been moved into the center portion of the display, and a third video 308 has moved into a lower portion of the display. This movement of videos may have occurred automatically based on completion of the first video 304. Alternatively, the movement of videos may have occurred based on user intervention, e.g., the user swiping up on the display to move to a “next” video (i.e., the second video 306). The upper portion of the display can represent a “previous” position that displays a video (i.e., video 304) that is positioned within the video channel immediately before the center, featured video (video 306 in example scenario 350). The lower portion of the display can represent a “next” position that displays a video (i.e., video 308) that is positioned within the video channel immediately before after the center, featured video. The immersive viewer 302 includes an “exit” icon 310 that allows the user to close the immersive viewer 302 and return to the grid-based content feed.

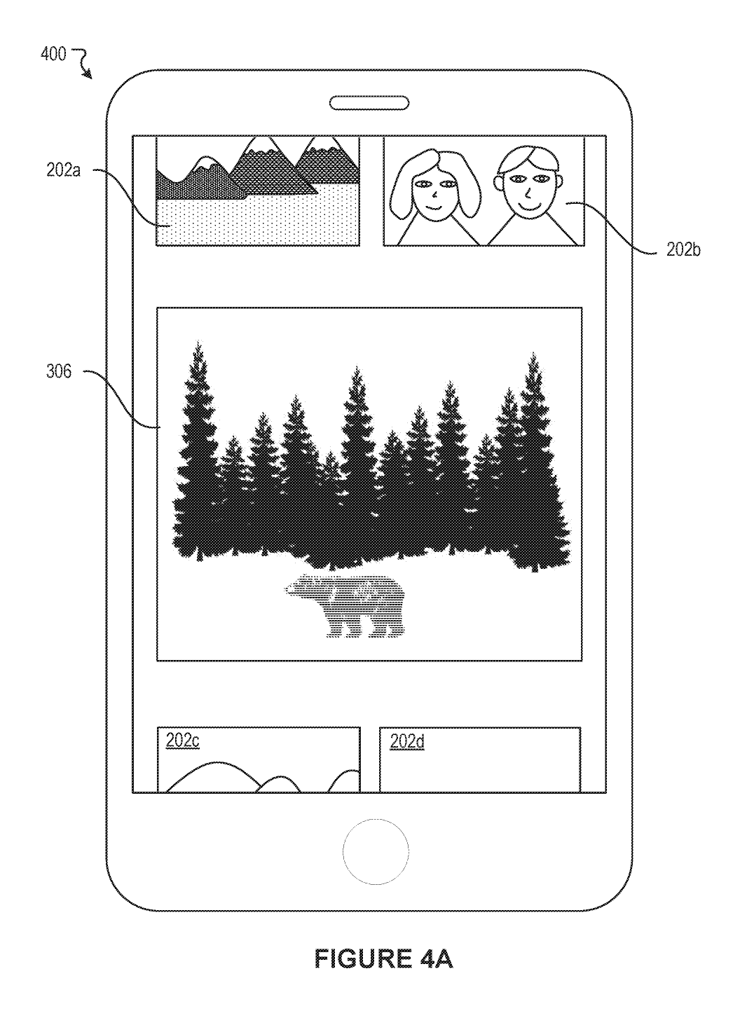

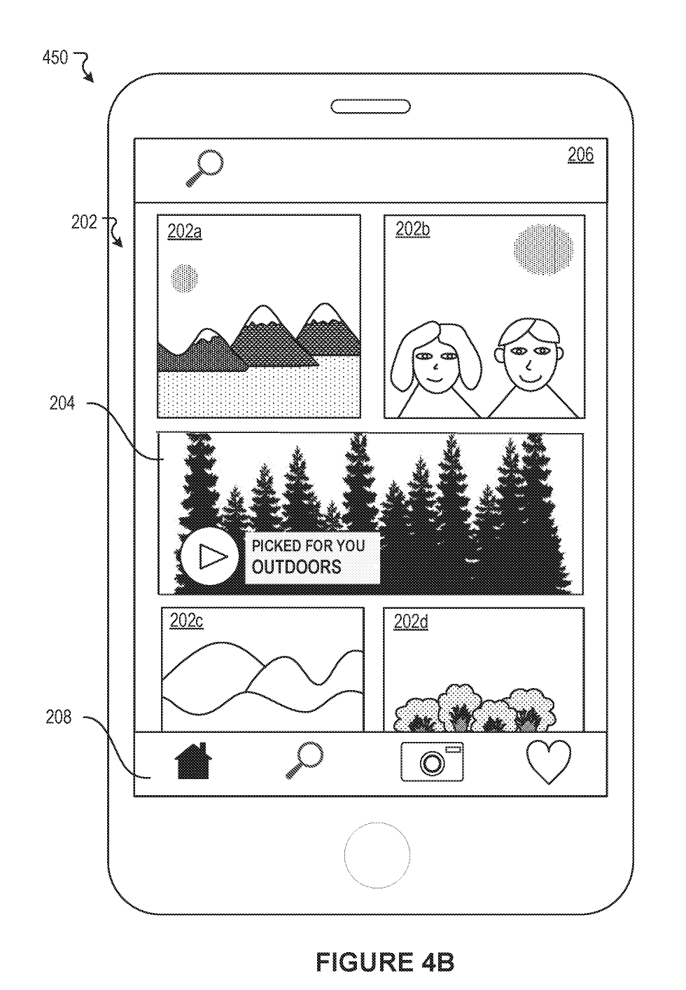

FIG. 4A illustrates an example scenario 400 associated with transitioning from an immersive viewer to a grid-based content feed. In the example scenario 400, the graphical user interface is in the middle of transitioning from the immersive viewer 302 of FIG. 3B to a grid-based content feed. In the example scenario 400, the user chose to exit the immersive viewer 302 during playback of the second video 306. Playback of the video channel, i.e., of the second video 306, continues through the transition. Display elements, such as media content items 202a-d are being moved back into the display to gradually form the grid-based content feed.

FIG. 4B illustrates an example scenario 450 associated with presenting a grid-based content feed. In the example scenario 450, all display elements of the grid-based content feed have been moved back into the display. The video channel 204 continues video playback from the immersive viewer. This is demonstrated in FIG. 4B in that the video channel 204 no longer depicts the original video from when the grid-based content feed was previously displayed (i.e., the first video 304), and now depicts the video that was playing within the immersive viewer when the user closed the immersive viewer (i.e., the second video 304).

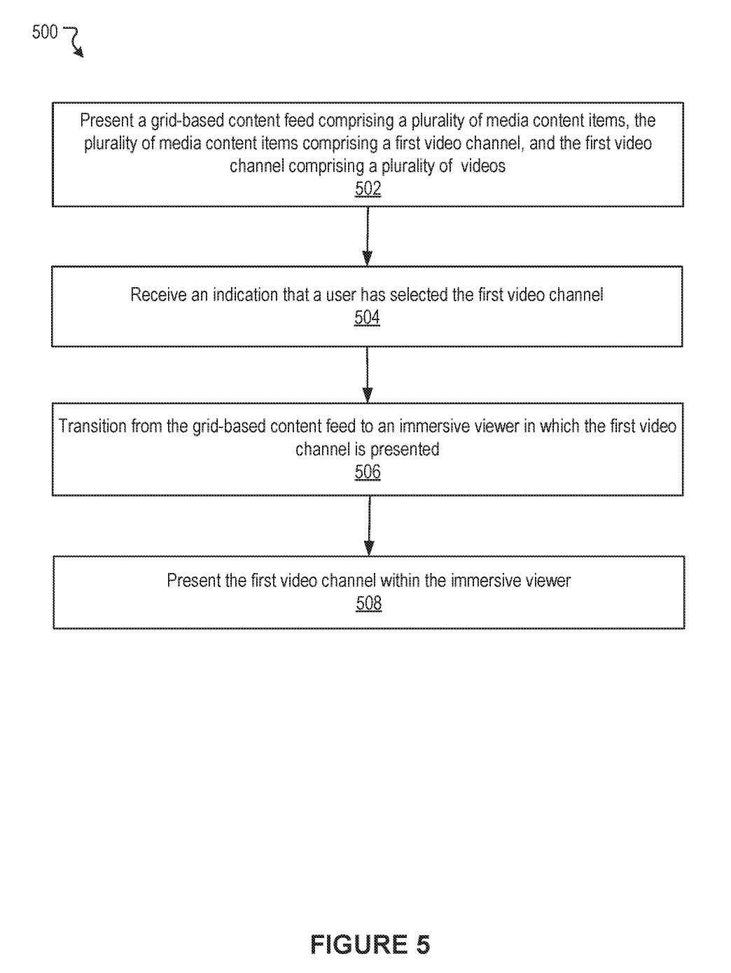

FIG. 5 illustrates an example method 500 associated with transitioning from a grid-based content feed to an immersive viewer, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can present a grid-based content feed comprising a plurality of media content items, the plurality of media content items comprising a first video channel, and the first video channel comprising a plurality of videos. At block 504, the example method 500 can receive an indication that a user has selected the first video channel. At block 506, the example method 500 can transition from the grid-based content feed to an immersive viewer in which the first video channel is presented. At block 508, the example method 500 can present the first video channel within the immersive viewer.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content interaction interface module 646. The content interaction interface module 646 can, for example, be implemented as the content interaction interface module 102, as discussed in more detail herein. As discussed previously, it should be appreciated that there can be many variations or other possibilities. For example, in some embodiments, one or more functionalities of the content interaction interface module 646 can be implemented in the user device 610.

### Hardware Implementation

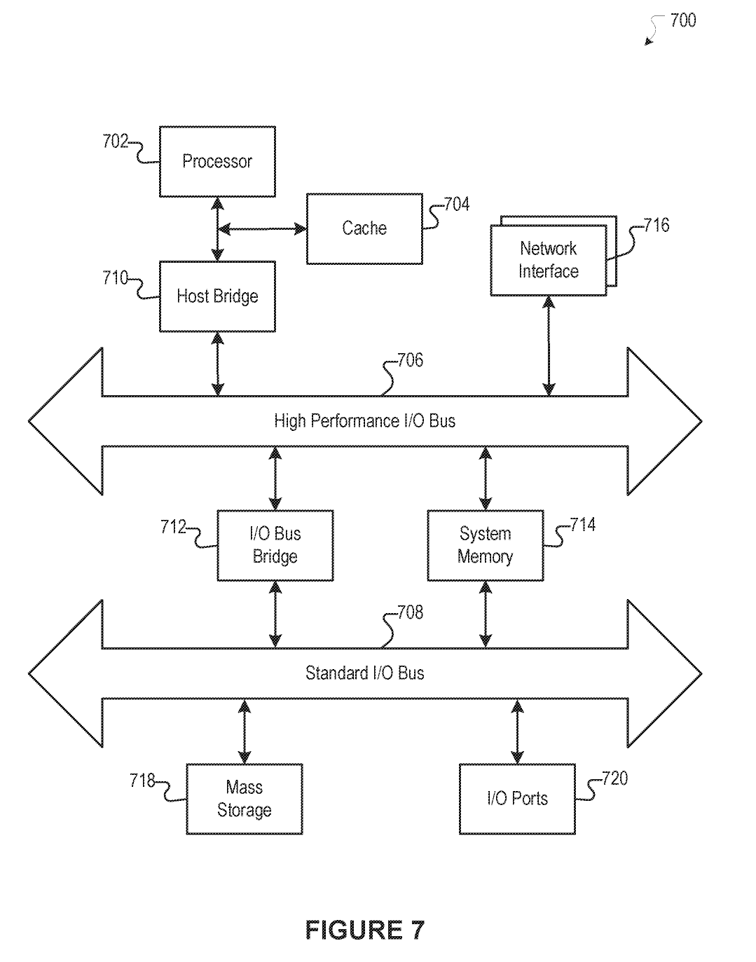

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
presenting, by a computing system, a grid-based content feed comprising a plurality of media content items, the plurality of media content items comprising a first video channel, and the first video channel comprising a plurality of videos;
receiving, by the computing system, an indication that a user has selected the first video channel;
transitioning, by the computing system, from the grid-based content feed to an immersive viewer in which the first video channel is presented; and
presenting, by the computing system, the first video channel within the immersive viewer.

2. The computer-implemented method of claim 1, wherein the presenting the grid-based content feed comprises automatically initiating playback of the video channel within the grid-based content feed.

3. The computer-implemented method of claim 2, wherein the playback of the video channel continues through the transitioning from the grid-based content feed to the immersive viewer and the presenting the first video channel within the immersive viewer.

4. The computer-implemented method of claim 3, further comprising
transitioning from the immersive viewer to the grid-based content feed; and
presenting the grid-based content feed, wherein
playback of the video channel continues through the transitioning from the immersive viewer to the grid-based content feed and the presenting the grid-based content feed.

5. The computer-implemented method of claim 1, wherein the transitioning from the grid-based content feed to the immersive viewer comprises translating the remaining plurality of media content items other than the first video channel off screen.

6. The computer-implemented method of claim 5, wherein the transitioning from the grid-based content feed to the immersive viewer further comprises translating the video channel to a center portion of a display.

7. The computer-implemented method of claim 6, wherein the transitioning from the grid-based content feed to the immersive viewer further comprises expanding the first video channel from a cropped view to an uncropped view of the first video channel.

8. The computer-implemented method of claim 1, wherein the video channel comprises a plurality of videos that are added to the video channel based on a shared characteristic.

9. The computer-implemented method of claim 8, wherein the video channel comprises a plurality of videos that are associated with a particular topic.

10. The computer-implemented method of claim 8, wherein the video channel comprises a plurality of videos that are associated with a particular event.

11. A system comprising:
at least one processor; and
a memory storing instructions that, when executed by the at least one processor, cause the system to perform a method comprising:
presenting a grid-based content feed comprising a plurality of media content items, the plurality of media content items comprising a first video channel, and the first video channel comprising a plurality of videos;
receiving an indication that a user has selected the first video channel;
transitioning from the grid-based content feed to an immersive viewer in which the first video channel is presented; and
presenting the first video channel within the immersive viewer.

12. The system of claim 11, wherein the presenting the grid-based content feed comprises automatically initiating playback of the video channel within the grid-based content feed.

13. The system of claim 12, wherein the playback of the video channel continues through the transitioning from the grid-based content feed to the immersive viewer and the presenting the first video channel within the immersive viewer.

14. The system of claim 13, wherein the method further comprises
transitioning from the immersive viewer to the grid-based content feed; and
presenting the grid-based content feed, wherein
playback of the video channel continues through the transitioning from the immersive viewer to the grid-based content feed and the presenting the grid-based content feed.

15. The system of claim 11, wherein the transitioning from the grid-based content feed to the immersive viewer comprises translating the remaining plurality of media content items other than the first video channel off screen.

16. A non-transitory computer-readable storage medium including instructions that, when executed by at least one processor of a computing system, cause the computing system to perform a method comprising:
presenting a grid-based content feed comprising a plurality of media content items, the plurality of media content items comprising a first video channel, and the first video channel comprising a plurality of videos;
receiving an indication that a user has selected the first video channel;
transitioning from the grid-based content feed to an immersive viewer in which the first video channel is presented; and
presenting the first video channel within the immersive viewer.

17. The non-transitory computer-readable storage medium of claim 16, wherein the presenting the grid-based content feed comprises automatically initiating playback of the video channel within the grid-based content feed.

18. The non-transitory computer-readable storage medium of claim 17, wherein the playback of the video channel continues through the transitioning from the grid-based content feed to the immersive viewer and the presenting the first video channel within the immersive viewer.

19. The non-transitory computer-readable storage medium of claim 18, wherein the method further comprises
transitioning from the immersive viewer to the grid-based content feed; and
presenting the grid-based content feed, wherein
playback of the video channel continues through the transitioning from the immersive viewer to the grid-based content feed and the presenting the grid-based content feed.

20. The non-transitory computer-readable storage medium of claim 16, wherein the transitioning from the grid-based content feed to the immersive viewer comprises translating the remaining plurality of media content items other than the first video channel off screen.
